(19) United States
(12) Patent Application Publication
(10) Pub. No.: US 2014/0325271 A1
(43) Pub. Date: Oct. 30, 2014

(54) TERMINAL DEVICE, INFORMATION PROCESSING METHOD, AND COMPUTER PROGRAM PRODUCT

(71) Applicant: KABUSHIKI KAISHA TOSHIBA, Tokyo (JP)

(72) Inventors: Daisuke AJITOMI, Tokyo (JP); Keisuke MINAMI, Kawasaki-shi (JP); Masataka GOTO, Yokohama-shi (JP)

(73) Assignee: KABUSHIKI KAISHA TOSHIBA, Tokyo (JP)

(21) Appl. No.: 14/202,253

(22) Filed: Mar. 10, 2014

(30) Foreign Application Priority Data
Apr. 26, 2013 (JP) 2013-094157

(51) Int. Cl. G06F 11/14

(52) U.S. Cl. CPC G06F 11/1474
USPC 714/16

(57) ABSTRACT

According to an embodiment, a terminal device includes a memory unit, a managing unit, a manipulation recording unit, and at least one of first and second detecting units. The managing unit generates and deletes a processing unit which executes a transaction for individually manipulating data with respect to data elements and data containers stored in the memory unit. The manipulation recording unit records manipulation information while a transaction is being executed by the processing unit. The first and second detecting units detect the presence or absence of competition. The first detecting unit detects competition during an execution state of a transaction as set by the processing unit. The second detecting unit detects competition during a commit preparation state of a transaction as set by the processing unit. When at least either the first detecting unit or the second detecting unit detects competition, the processing unit aborts the transaction.

### CROSS-REFERENCE TO RELATED APPLICATIONS

This application is based upon and claims the benefit of priority from Japanese Patent Application No. 2013-094157, filed on Apr. 26, 2013; the entire contents of which are incorporated herein by reference.

### FIELD

Embodiments described herein relate generally to a terminal device, an information processing method, and a computer program product.

### BACKGROUND

Typically, for example, graph databases are known as databases aimed at enabling high-speed searching of pertinent information. For example, in a large-scale database such as a social graph, there is a demand for achieving enhancement in the concurrent execution efficiency of write transactions.

However, in the conventional technology, when there is a large number of nodes each having a large number of edges (i.e., when there is a large number of hub nodes); competition for writing is likely to occur with respect to the hub nodes, thereby making it difficult to achieve enhancement in the concurrent execution efficiency of write transactions.

### BRIEF DESCRIPTION OF THE DRAWINGS

FIG. 1 is a block diagram illustrating a configuration of a terminal device according to an embodiment;

FIG. 2 is a diagram illustrating a configuration in which each of a plurality of data elements has a data container;

FIG. 3 is a diagram that schematically illustrates a structure of manipulation information and a recording location of the manipulation information;

FIG. 4 is a diagram illustrating the transition of data in the manipulation information in the case when a data writing transaction and a data updating transaction are executed;

FIG. 5 is an activity diagram illustrating an example of operations performed in the terminal device in an execution state of a transaction;

FIG. 6 is an activity diagram illustrating an example of operations performed in the terminal device in a commit preparation state of a transaction;

FIG. 7 is a diagram that schematically illustrates a specific example of the case in which the terminal device executes a plurality of transactions;

FIG. 8 is a diagram illustrating operations performed in the case (Example) in which the terminal device according to the embodiment executes transactions Tx(A) and Tx(C) illustrated in FIG. 7 and illustrating operations performed in Comparative example; and

FIG. 9 is a diagram illustrating a configuration in the case in which the data elements and the data containers illustrated in FIG. 2 are applied to graph structure data.

### DETAILED DESCRIPTION

According to an embodiment, a terminal device includes a memory unit, a managing unit, a manipulation recording unit, and at least one of a first detecting unit and a second detecting unit. The memory unit is configured to store therein a data element which holds a data container. The managing unit is configured to perform generation and deletion of a processing unit which executes a transaction for individually manipulating data with respect to the data element and the data container stored in the memory unit. The manipulation recording unit is configured to, while a transaction is being executed by the processing unit, record manipulation information containing manipulation details with respect to target data for manipulation and identification information which enables transaction identification. At least one of the first detecting unit and the second detecting unit is configured to detect presence or absence of competition which may cause a loss in the consistency of data. The first detecting unit detects competition between manipulation with respect to a data element and manipulation with respect to a data container during an execution state of a transaction as set by the processing unit. The second detecting unit detects competition between manipulation with respect to a data element and manipulation with respect to a data container based on the manipulation information during a commit preparation state of a transaction as set by the processing unit. When at least either one of the first detecting unit and the second detecting unit detects competition, the processing unit aborts the transaction.

Embodiment is described below with reference to the accompanying drawings.

### Embodiment

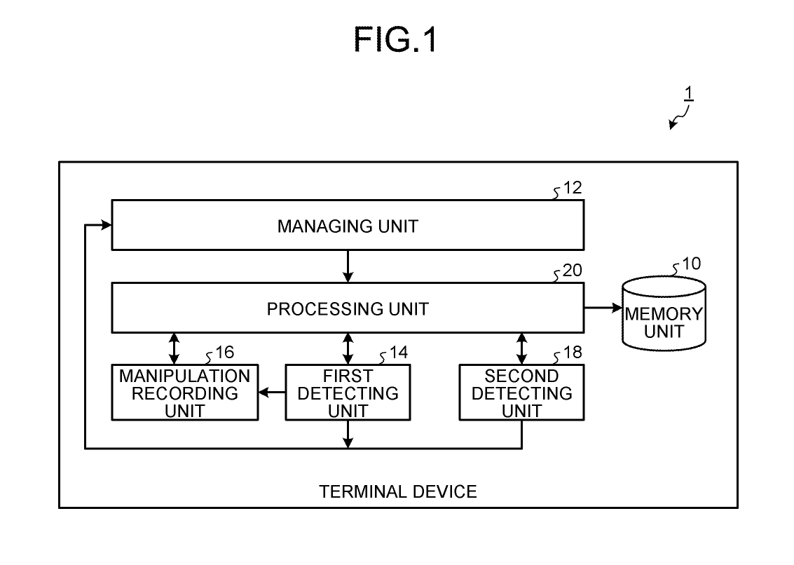

FIG. 1 is a block diagram illustrating a configuration of a terminal device 1 according to the embodiment. The terminal device 1 is implemented using, for example, a general-purpose computer. Thus, the terminal device 1 has the functions of a computer that includes a central processing unit (CPU), a memory device, and an interface. Alternatively, the terminal device 1 can be implemented using a server device or using a digital device such as a personal computer (PC), a digital television set, a hard disk recorder, a slate PC, or a smartphone.

As illustrated in FIG. 1, the terminal device 1 includes a memory unit 10, a managing unit 12, a first detecting unit 14, a manipulation recording unit 16, and a second detecting unit 18. The memory unit 10 is configured with, for example, a single hard disk drive (HDD) or a plurality of HDDs. Alternatively, the memory unit 10 can be a nonvolatile auxiliary memory device (such as a solid state drive (SSD), a flash memory, or a magnetic random access memory (MRAM)), or can be a main memory device. The managing unit 12, the first detecting unit 14, the manipulation recording unit 16, and the second detecting unit 18 can be implemented either using hardware circuitry or using software executed in the CPU.

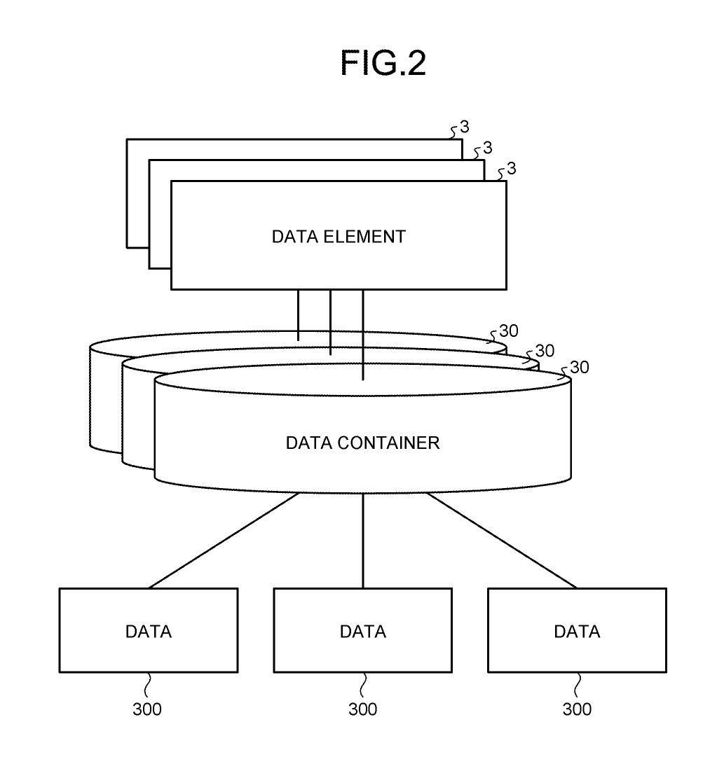

The memory unit 10 is used to store therein a plurality of data elements. FIG. 2 is a diagram illustrating a configuration in which each of a plurality of data elements (elements) has a data container. Herein, each data element 3 has a data container 30, which is a data management mechanism for providing addition/updating/deletion/acquisition (retrieval) of a plurality of pieces of data 300. Herein, the data containers 30 can be implemented in various forms such as B-Tree, Hash, List, or SkipList.

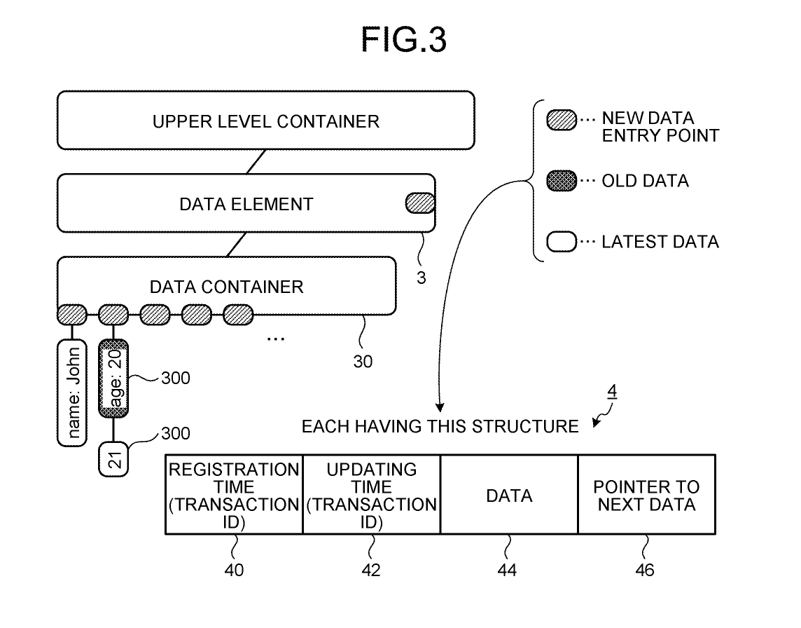

For example, each data element 3 represents a node or an edge of a graph database. Each data container 30 includes properties (such as “name” and “age” illustrated in FIG. 3). Each piece of data 300 represents a value such as a numerical value or a name.

The managing unit (a transaction managing unit) 12 (see FIG. 1) performs generation and deletion of a processing unit (a transaction processing unit) 20 (described later), to manage the processing unit 20. In the case of generating the processing unit 20, the managing unit 12 assigns identification information (a transaction ID) that enables unique identification of the processing unit 20. Moreover, at least during the time period in which the processing unit 20 exists, the managing unit 12 holds the assigned transaction ID in a corresponding manner to reference information for the processing unit 20. Furthermore, with respect to a query, in which the transaction ID serves as the key, issued by the first detecting unit 14 (described later) or the second detecting unit 18 (described later); the managing unit 12 sends a reply including the state of the transaction and including the processing completion time.

The processing unit 20 performs a plurality of manipulations (transactions) with respect to the data elements 3 and the pieces of data 300 in the data containers 30 (hereinafter, “the pieces of data 300 in the data containers 30” are sometimes referred to as “pieces of container data 300”), which are stored in the memory unit 10, while maintaining consistency.

In a transaction, for example, when numerical value data “A=100” and numerical value data “B=100” are stored in the memory unit 10 and when an operation “transfer 10 from A to B” is to be performed; it is guaranteed that either both of the two types of operations “A−10” and “B+10” are performed (A=90, B=110) or none of the two types of operations are performed (A=100, B=100).

For that reason, the processing unit 20 takes any one of the following four states, namely, an execution state, a commit preparation state, a commit completion state, and an abort state.

The execution state is a state in which manipulations are performed with respect to the data elements 3 or the pieces of container data 300. At the point of time when it is generated by the managing unit 12, the processing unit 20 is in the execution state. In the execution state, a series of manipulations is not committed (not defined) and can thus be rolled back. Moreover, in the execution state, regarding whether or not to actually perform manipulations, the processing unit 20 takes a call depending on the detection result of the first detecting unit 14 (described later).

The commit preparation state is a state in which a series of manipulations is completed and a manipulation completion time is obtained. In the commit preparation state, regarding whether or not to actually commit, the processing unit 20 takes a call depending on the detection result of the second detecting unit 18 (described later).

The commit completion state is a state in which a series of manipulations is defined in a committable condition. In the commit completion state, the processing unit 20 atomically replaces a transaction ID, which is specified in manipulation information 4 recorded by the manipulation recording unit 16 (described later), by the manipulation completion time. Moreover, the processing unit 20 can write the log of a series of manipulations in a nonvolatile memory area, and secure the persistence of commit data. Lastly, the processing unit 20 terminates.

The abort state is a state in which an executed manipulation is cancelled in a non-committable condition. For example, when there is competition for writing or when an upper level application performs cancellation, the processing unit 20 cancels the executed manipulation. In the abort state, the processing unit 20 deletes (rolls back) all pieces of manipulation information 4, which are recorded by the manipulation recording unit 16 (described later), and terminates. Meanwhile, the processing unit 20 holds state information that indicates the four states.

In the execution state, the first detecting unit 14 detects competition (the presence or absence of competition) between a manipulation performed with respect to a data element 3 and a manipulation performed with respect to the piece of data 300 in a data container 30. Herein, the first detecting unit 14 detects competition that may cause a loss in the consistency of the data.

In the execution state, the manipulation recording unit 16 records the manipulation information 4 at a manipulation location (described later). Moreover, the manipulation recording unit 16 records manipulation location information, which indicates the manipulation location, in the processing unit 20. The manipulation location information serves as a pointer for the purpose of referring to the manipulation information 4 and, for example, is a pointer to the pre-updating data (the old data).

In the commit preparation state, the second detecting unit 18 detects competition (the presence or absence of competition) between a manipulation performed with respect to a data element 3 and a manipulation performed with respect to the piece of data 300 in a data container 30. Herein, the second detecting unit 18 detects competition that may cause a loss in the consistency of the data.

Given below is the detailed explanation about the manipulation information 4 recorded by the manipulation recording unit 16. FIG. 3 is a diagram that schematically illustrates a structure of the manipulation information 4 and a recording location of the manipulation information 4. As illustrated in FIG. 3, the manipulation information 4 contains a first area 40, a second area 42, a third area 44, and a fourth area 46. Herein, it is assumed that the data (the manipulation contents: values) is written in the third area 44. Moreover, when the data is updated, a new piece of manipulation information 4 is written in the third area 44 (appending type). At the stage when the manipulation information 4 which has now become the old data due to appending is no more referred to, it can be retrieved/deleted.

The first area 40 is an area in which the manipulation recording unit 16 writes a completion time (a registration time) at the time when, for example, a transaction for writing data in the third area 44 is completed. Besides, during the period in which the transaction is executed and completed, in the first area 40 is written the identification information (the transaction ID) that enables identification of the transaction being executed.

The second area 42 is an area in which the manipulation recording unit 16 writes an updating time at the time when a transaction for updating the data written in the third area 44 is completed. Besides, until the transaction for updating the data is completed, in the second area 42 is written another value. For example, when the transaction for updating the data written in the third area 44 is not executed, in the second area 42 is written a value (for example, “0”) which indicates that the data written in the third area 44 is valid. Moreover, during the period in which the transaction for updating the data written in the third area 44 is executed and completed, in the second area 42 is written the identification information (the transaction ID) that enables identification of the transaction being executed.

The third area 44 is an area in which, as described above, the manipulation recording unit 16 writes the data (values) subjected to manipulation.

The fourth area 46 is an area in which the manipulation recording unit 16 writes the pointer to the next data (i.e., the data to be updated next). If the next data does not exist, then it is assumed that in the fourth area 46 is written information (for example, “NULL”) which indicates that the next data does not exist.

The manipulation information 4 has the same data structure in the data elements 3 and the data containers 30, as well as has the same data structure in the old data and the latest data. Meanwhile, in FIG. 3 is illustrated a case in which an upper level container is provided with respect to each data element 3.

For example, in the case of adding a data element 3, the manipulation recording unit 16 records a transaction ID at the start time of a new data entry point of the upper level container to which the data element 3 belongs, and records the new data element 3 in the data. Herein, the manipulation recording unit 16 writes in the second area 42 the information (for example, “0”) which indicates non-updating (valid); and writes in the fourth area 46, as an initial value, the information (for example, “NULL”) which indicates that the next data does not exist.

Moreover, for example, in the case of adding a piece of container data 300, the manipulation recording unit 16 records a transaction ID at the start time of a new data entry point of the data container 30 to which the piece of container data 300 belongs, and records the new piece of container data 300 in the data. Herein, the manipulation recording unit 16 writes in the second area 42 the information (for example, “0”) which indicates non-updating (valid); and writes in the fourth area 46, as an initial value, the information (for example, “NULL”) which indicates that the next data does not exist.

In the case of updating a data element 3, the manipulation recording unit 16 records the transaction ID in the second area 42 of the old data element 3 (which is to be updated), and records the address of the updated data element in the fourth area 46 of the old data element (which is to be updated). Then, the manipulation recording unit 16 records the transaction ID in the first area 40 of the updated data element, and records the updated data element in the third area 44 of the updated data element.

In the case of updating a piece of container data 300, the manipulation recording unit 16 records the transaction ID in the second area 42 of the old piece of container data (which is to be updated), and records the address of the updated piece of container data in the fourth area 46 of the old piece of container data (which is to be updated). Then, the manipulation recording unit 16 records the transaction ID in the first area 40 of the updated piece of container data, and records the updated piece of container data in the third area 44 of the updated piece of container data.

In the case of deleting a data element 3, the manipulation recording unit 16 records the transaction ID in the second area 42 of the old data element (which is to be deleted).

In the case of deleting a piece of container data 300, the manipulation recording unit 16 records the transaction ID in the second area 42 of the old piece of container data (which is to be deleted).

Meanwhile, in the commit completion state, the transaction ID is atomically replaced by the manipulation completion time. In contrast, in the abort state, the transaction ID is atomically returned to the initial value (such as “0”). Herein, it is assumed that, when the transaction ID has the initial value, it does not represent the manipulation information 4 but represents the latest data element that can be the target for updating or represents the latest piece of container data. Meanwhile, in the manipulation information 4, it is also possible to have an area for specifying the manipulation type such as addition/updating/deletion. Moreover, it is possible to have an area for setting a deletion flag.

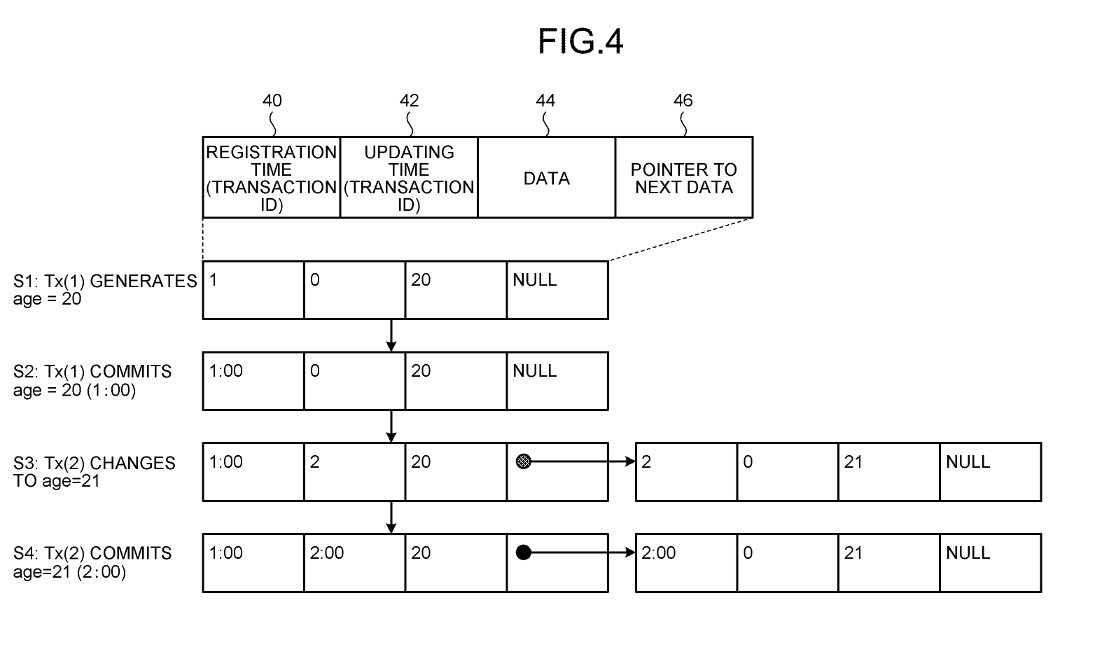

FIG. 4 is a diagram illustrating the transition of data in the manipulation information 4 in the case when a data writing transaction and a data updating transaction are executed. In FIG. 4, Tx(1) represents a transaction performing data writing (generation), and Tx(2) represents a transaction performing data updating.

When the transaction Tx(1) is executed, the first area 40 has a transaction ID “1” written therein; the second area 42 has a value “0”, which indicates data validity, written therein; the third area 44 has data (a value 20 indicating “age”) written therein; and the fourth area 46 has “NULL”, which indicates that the next data does not exist, written therein (first state: S1). Thus, the state S1 represents the execution state of the transaction Tx(1).

It is assumed that the transaction Tx(1) has a commit completion time of 1:00. Once the transaction Tx(1) is completely committed, in the first area 40 is written the commit completion time (1:00) of the transaction Tx(1) (second state: S2). Thus, the state S2 represents the commit completion state of the transaction Tx(1).

When the transaction Tx(2) is executed, the second area 42 has a transaction ID “2” written therein; the fourth area 46 has the pointer to the next data written therein; and writing is done with respect to a new piece of manipulation information 4. In the new piece of manipulation information 4, the first area 40 has the transaction ID “2” written therein; the second area 42 has the value “0”, which indicates data validity, written therein; the third area 44 has data (a value 21 to which “age” is updated) written therein; and the fourth area 46 has “NULL”, which indicates that the next data does not exist, written therein (third state: S3). Thus, the state S3 represents the execution state of the transaction Tx(2).

The transaction Tx(2) has a commit completion time of 2:00. Once the transaction Tx(2) is completely committed, in the second area 42 of the manipulation information 4, in the third area 44 of which is written the data (20), is written the updating time of the data (20). Moreover, in the first area 40 of the manipulation information 4, in the third area 44 of which is written the data (21), is written the commit completion time (2:00) of the transaction Tx(2) (fourth state: S4). Thus, the state S4 represents the commit completion state of the transaction Tx(2).

Hence, the value 20 of “age” happens to be valid from 1:00 to 2:00. Meanwhile, if the transaction Tx(2) is aborted, the operations performed in the transaction Tx(2) are cancelled out.

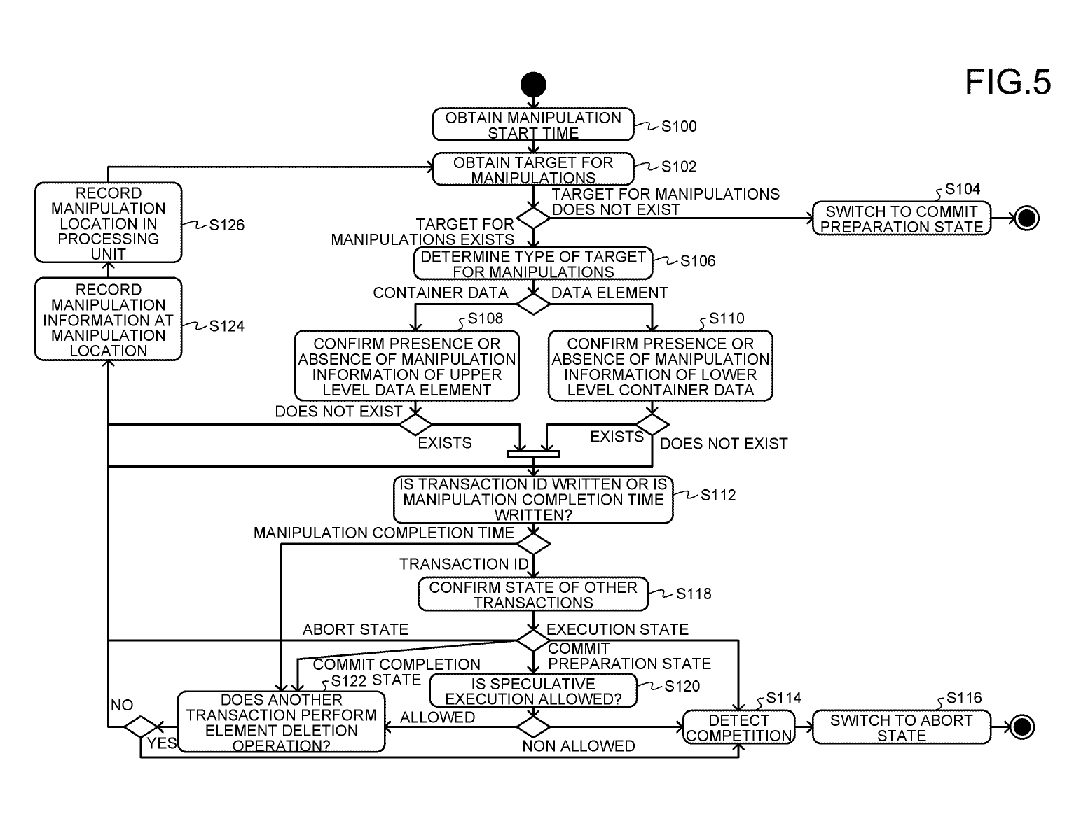

Given below is the explanation about the operations performed in the terminal device 1. FIG. 5 is an activity diagram illustrating an example of operations performed in the terminal device 1 in the execution state of a transaction. Firstly, the processing unit 20 obtains the manipulation start time of the transaction (S100).

Then, the processing unit 20 obtains a target for manipulations by the transaction (S102). Herein, in order to skip the old data and to obtain the latest data, the processing unit 20 makes use of the manipulation start time obtained at S100.

More particularly, if the manipulation start time of a piece of data is between the registration time and the updating time, then the processing unit 20 considers that piece of data to be the latest data in the transaction and obtains the data. Moreover, if the manipulation start time of a piece of data is earlier than the registration time, then the processing unit 20 considers the piece of data as data to be generated in future for the transaction and considers the data to be nonexistent. On the other hand, if the manipulation start time of a piece of data is later than the updating time, then the processing unit 20 considers the piece of data to be the data deleted in the past for the transaction and considers the data to be nonexistent. At that time, the processing unit 20 refers to the fourth area 46 of the manipulation information 4. Then, if the next data exists, the processing unit 20 refers to the next data and refers to the registration time and the updating time in an identical manner to determine whether or not the next data is the latest data in the transaction. Meanwhile, if the second area has another transaction ID written therein, then the processing unit 20 performs a determination operation equivalent to S118 to S120 described later. That is, depending on the state of that transaction, the processing unit 20 determines whether or not to obtain the data. More particularly, in the abort state, the processing unit 20 obtains the data by considering it to be the latest data. In the execution state, the processing unit 20 aborts on the supposition that there is competition which may cause a loss in the consistency of the data. In the commit completion state, the processing unit considers the data to be the updated (deleted) data, and moves on to checking the next data. In the commit preparation state, the behavior of the processing unit 20 changes depending on whether or not speculative execution is allowed. In the case when speculative execution is allowed, the processing unit 20 moves on to checking the next data in an identical manner to that in the commit completion state. On the other hand, in the case when speculative execution is not allowed; the processing unit 20 aborts on the supposition that there is competition.

If the target for manipulations does not exist, the processing unit 20 switches the concerned transaction to the commit preparation state (S104). On the other hand, when the target for manipulations exists, the processing unit 20 instructs the first detecting unit 14 to detect the presence or absence of competition.

The first detecting unit 14 determines the type of the target for manipulations (whether it is a data element 3 or the data 300 in a data container 30 (i.e., a piece of container data 300)) (S106). If the target for manipulations is a piece of container data 300, then the first detecting unit 14 confirms the presence or absence of the manipulation information 4 of the data element 3 present at the corresponding upper level (S108). On the other hand, if the target for manipulations is a data element 3, then the first detecting unit 14 confirms the presence or absence of the manipulation information 4 of the container data 300 present at the corresponding lower level (i.e., the container data 300 belonging to the data element 3) (S110). Herein, whether or not the manipulation information 4 exists indicates, more specifically, whether or not the manipulation information 4 exists for which it is likely to have competition that may cause a loss in the consistency of data. Thus, the first detecting unit 14 performs the determination depending on whether the second area 42 of the manipulation information 4 has the transaction ID written therein or depending on whether the manipulation completion time is later than the manipulation start time.

When the manipulation information 4 of a data element 3 or a piece of container data 300 exists, the first detecting unit 14 determines whether the second area 42 of the manipulation information 4 has the transaction ID written therein or the manipulation completion time written therein as confirmed at S108 or S110 (S112). On the other hand, if the manipulation information 4 of a data element 3 or a piece of container data 300 does not exist, then the first detecting unit 14 notifies the manipulation recording unit 16 to record the manipulation information 4.

If the manipulation completion time (i.e., the manipulation completion time later than the manipulation start time obtained at S100) is specified in the second area 42 of the manipulation information 4, then the first detecting unit 14 determines whether any other transaction performs an element deletion operation (S122). If no such transaction exists, then the first detecting unit 14 notifies the manipulation recording unit 16 to record the manipulation information 4. On the other hand, if such a transaction exists (i.e., if an element deletion operation is to be performed), then the first detecting unit 14 detects that there is competition which may cause a loss in the consistency of the data, and notifies the processing unit 20 about the same (S114). Upon receiving the notification about the competition from the first detecting unit 14, the processing unit 20 switches the concerned transaction to the abort state (S116).

Meanwhile, if the second area 42 of the manipulation information 4 has the transaction ID written therein, then the first detecting unit 14 confirms the state of the other transactions by querying the managing unit 12 (S118).

Even in the case when the other transactions are in the execution state, the first detecting unit 14 detects that there is competition which may cause a loss in the consistency of the data, and notifies the processing unit 20 about the same (S114). However, if the other transactions are in the commit preparation state, then the first detecting unit 14 determines whether or not speculative execution is allowed (S120). Alternatively, if the other transactions are in the abort state, then the first detecting unit 14 notifies the manipulation recording unit 16 to record the manipulation information 4. Still alternatively, if the other transactions are in the commit completion state (i.e., if the other transactions are switching to the completion state or if the change from the transaction ID to the updating time is not completed), then the first detecting unit 14 performs an operation identical to the case in which the manipulation completion time is specified at S112. That is, the first detecting unit 14 determines whether or not any other transaction performs an element deletion operation (S122). If no such transaction exists, then the first detecting unit 14 notifies the manipulation recording unit 16 to record the manipulation information 4. On the other hand, if such a transaction exists (i.e., if an element deletion operation is to be performed), then the first detecting unit 14 detects that there is competition which may cause a loss in the consistency of the data, and notifies the processing unit 20 about the same (S114).

Even in the case when speculative execution is not allowed, the first detecting unit 14 detects that there is competition which may cause a loss in the consistency of the data, and notifies the processing unit 20 about the same (S114). On the other hand, when speculative execution is allowed, the first detecting unit 14 determines whether any other transaction performs an element deletion operation (S122).

If any other transaction performs an element deletion operation, then the first detecting unit 14 detects that there is competition which may cause a loss in the consistency of the data, and notifies the processing unit 20 about the same (S114). However, if no other transaction performs an element deletion operation, then the first detecting unit 14 notifies the manipulation recording unit 16 to record the manipulation information 4.

In response to the notification received from the first detecting unit 14, the manipulation recording unit 16 records the manipulation information 4 at the manipulation location (S124). Moreover, the manipulation recording unit 16 records the manipulation location in the processing unit 20 (S126), and instructs the processing unit 20 to obtain a new target for manipulations (S102).

More particularly, the manipulation recording unit 16 performs the following operations. Herein, a manipulation performed by the manipulation recording unit 16 is basically either one of “addition”, “updating”, and “deletion”. However, the manipulation recording unit 16 can also be configured to perform manipulations not including updating.

For example, when the data stored in the memory unit 10 is graph structure data, the manipulation recording unit 16 performs addition/deletion at the level of nodes/edges and performs addition/updating/deletion at the level of container data (property information, or edge information held by nodes) belonging to nodes/edges.

Meanwhile, as the manipulation for “addition”, the manipulation recording unit 16 can be configured to perform either only generation or generation as well as appending.

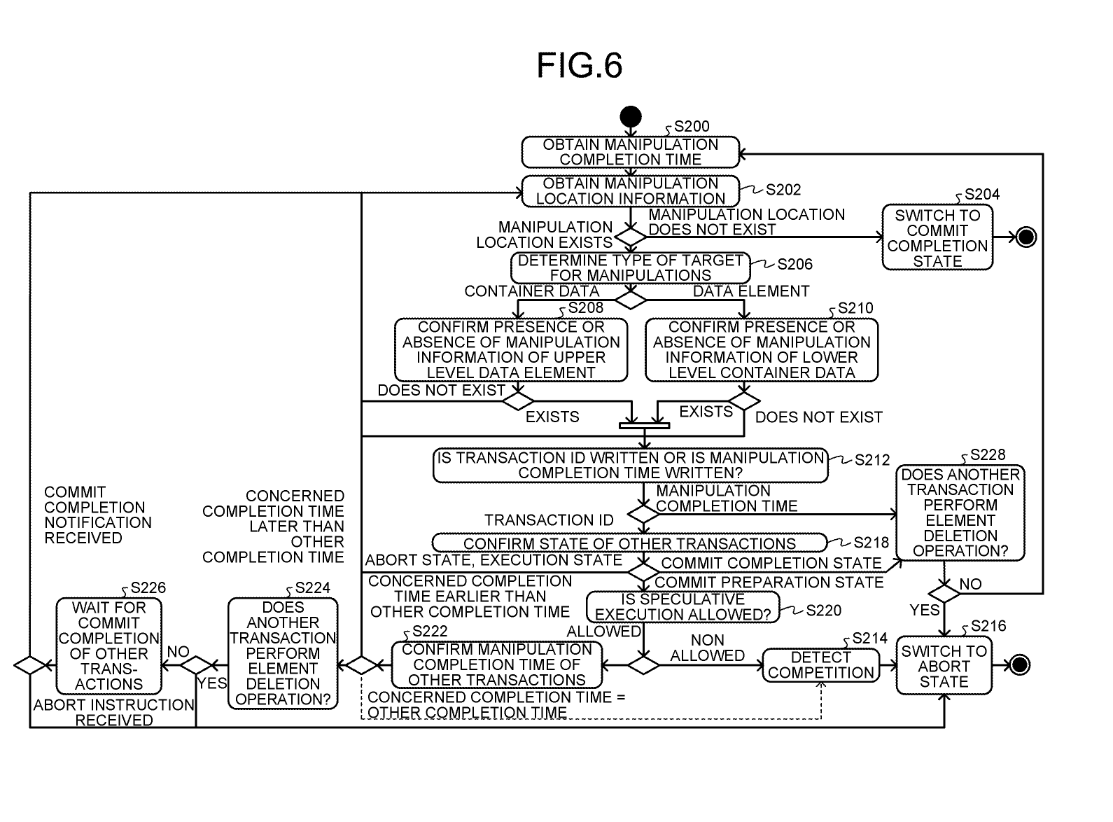

FIG. 6 is an activity diagram illustrating an example of operations performed in the terminal device 1 in the commit preparation state of a transaction. Firstly, the processing unit 20 obtains the manipulation completion time of the transaction (S200). Herein, as the manipulation completion time, the processing unit 20 considers the time taken by the transaction to switch to the commit preparation state.

Then, the processing unit 20 obtains the manipulation location information that contains the location at which the manipulation recording unit 16 recorded the manipulation information 4 (S202).

If the manipulation location does not exist, then the processing unit 20 switches the concerned transaction to the commit completion state (S204). However, when the manipulation location exists, the processing unit 20 instructs the second detecting unit 18 to detect the presence or absence of competition.

Then, the second detecting unit 18 determines the type of the target for manipulations (whether it is a data element 3 or the data 300 in a data container 30 (i.e., a piece of container data 300)) (S206).

If the target for manipulations is a piece of container data 300, then the second detecting unit 18 confirms the presence or absence of the manipulation information 4 of the data element 3 present at the corresponding upper level (S208). On the other hand, if the target for manipulations is a data element 3, then the second detecting unit 18 confirms the presence or absence of the manipulation information 4 of the container data 300 present at the corresponding lower level (i.e., the container data 300 belonging to the data element 3) (S210).

When the manipulation information 4 of a data element 3 or a piece of container data 300 exists, the second detecting unit 18 determines whether the second area 42 of the manipulation information 4 has the transaction ID written therein or the manipulation completion time written therein as confirmed at S208 or S210 (S212). On the other hand, if the manipulation information 4 of a data element 3 or a piece of container data 300 does not exist, then the second detecting unit 18 notifies the processing unit 20 to obtain new manipulation location information.

If the second area 42 of the manipulation information 4 has the manipulation completion time written therein, then the second detecting unit 18 determines whether any other transaction performs an element deletion operation (S228). If no such transaction exists, then the second detecting unit 18 notifies the processing unit 20 to obtain new manipulation location information. On the other hand, if such a transaction exists (i.e., if an element deletion operation is to be performed), then the second detecting unit 18 detects that there is competition which may cause a loss in the consistency of the data, and notifies the processing unit 20 about the same (S214). Upon receiving the notification about the competition from the second detecting unit 18, the processing unit 20 switches the concerned transaction to the abort state (S216).

Meanwhile, if the second area 42 of the manipulation information 4 has the transaction ID written therein, then the second detecting unit 18 confirms the state of the other transactions by querying the managing unit 12 (S218).

If the other transactions are in the commit preparation state, then the second detecting unit 18 determines whether or not speculative execution is allowed (S220). Alternatively, if the other transactions are in the abort state or in the execution state, then the second detecting unit 18 notifies the processing unit 20 to obtain new manipulation location information. Still alternatively, if the other transactions are in the commit completion state (i.e., if the other transactions are switching to the completion state or if the change from the transaction ID to the updating time is not completed), then the second detecting unit 18 performs an operation identical to the case in which the manipulation completion time is specified at S212. That is, the second detecting unit 18 determines whether or not any other transaction performs an element deletion operation (S228). If no such transaction exists, then the second detecting unit 18 notifies the processing unit 20 to obtain new manipulation location information. On the other hand, if such a transaction exists (i.e., if an element deletion operation is to be performed), then the second detecting unit 18 detects that there is competition which may cause a loss in the consistency of the data, and notifies the processing unit 20 about the same (S214).

Even in the case when speculative execution is not allowed, the second detecting unit 18 detects that there is competition which may cause a loss in the consistency of the data, and notifies the processing unit 20 about the same (S214). On the other hand, when speculative execution is allowed, the second detecting unit 18 confirms the manipulation completion time of the other transactions (S222).

When the completion time of the concerned transaction (concerned completion time) is later than the completion time of the other transactions (other completion time), the second detecting unit 18 determines whether any other transaction performs an element deletion operation (S224). On the other hand, when the concerned completion time is earlier than the other completion time, the second detecting unit 18 notifies the processing unit 20 to obtain new manipulation location information. Alternatively, if the concerned completion time is same as the other completion time, then the second detecting unit 18 detects that there is competition which may cause a loss in the consistency of the data, and notifies the processing unit 20 about the same (S214). However, herein, the processing unit 20 can be configured to ensure that the concerned completion time is not same as the other completion time.

If it is determined that another transaction performs an element deletion operation, then the second detecting unit 18 notifies the processing unit 20 to switch the concerned transaction to the abort state (S216). On the other hand, if it is determined that no other transaction performs an element deletion operation, then the second detecting unit 18 notifies the processing unit 20 to wait for commit completion of the other transactions (S226).

When the processing unit 20 receives an abort instruction, it switches the concerned transaction to the abort state (S216). On the other hand, when the processing unit receives a notification about commit completion, it obtains new manipulation location information (S202).

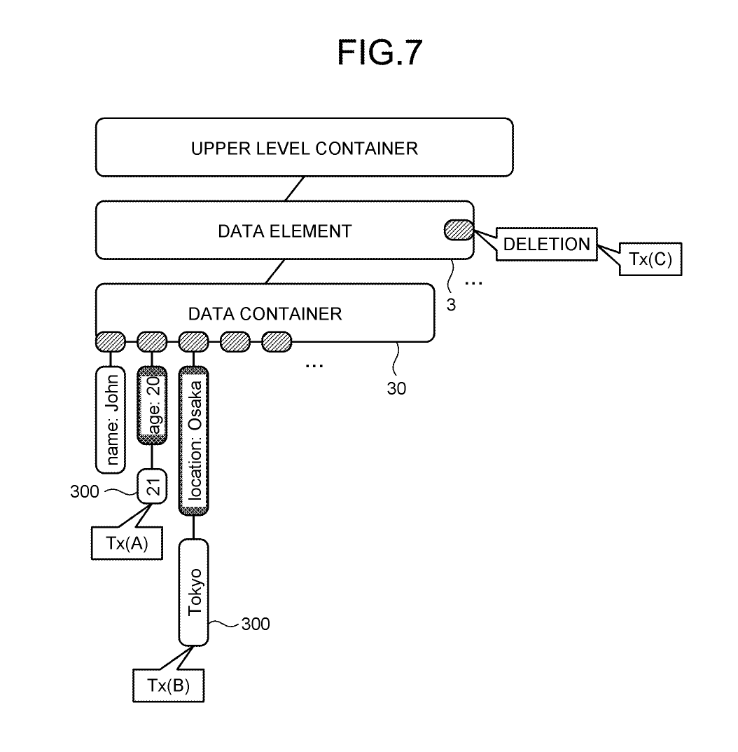

Given below is the explanation of a specific example of the case in which the terminal device 1 executes a plurality of transactions. FIG. 7 is a diagram that schematically illustrates a specific example of the case in which the terminal device 1 executes a plurality of transactions. With reference to FIG. 7, three transactions Tx(A), Tx(B), and Tx(C) perform the following operations.

The transaction Tx(A) is for updating “age” from “20” to “21”. The transaction Tx(B) is for changing “location” from “Osaka” to “Tokyo”. The transaction Tx(C) is for deleting the data element 3 having the data container 30.

The transactions Tx(A) and the Tx(B) do not compete with each other. However, the transactions Tx(A) and Tx(C) may compete with each other; and the transactions Tx(B) and Tx(C) may compete with each other.

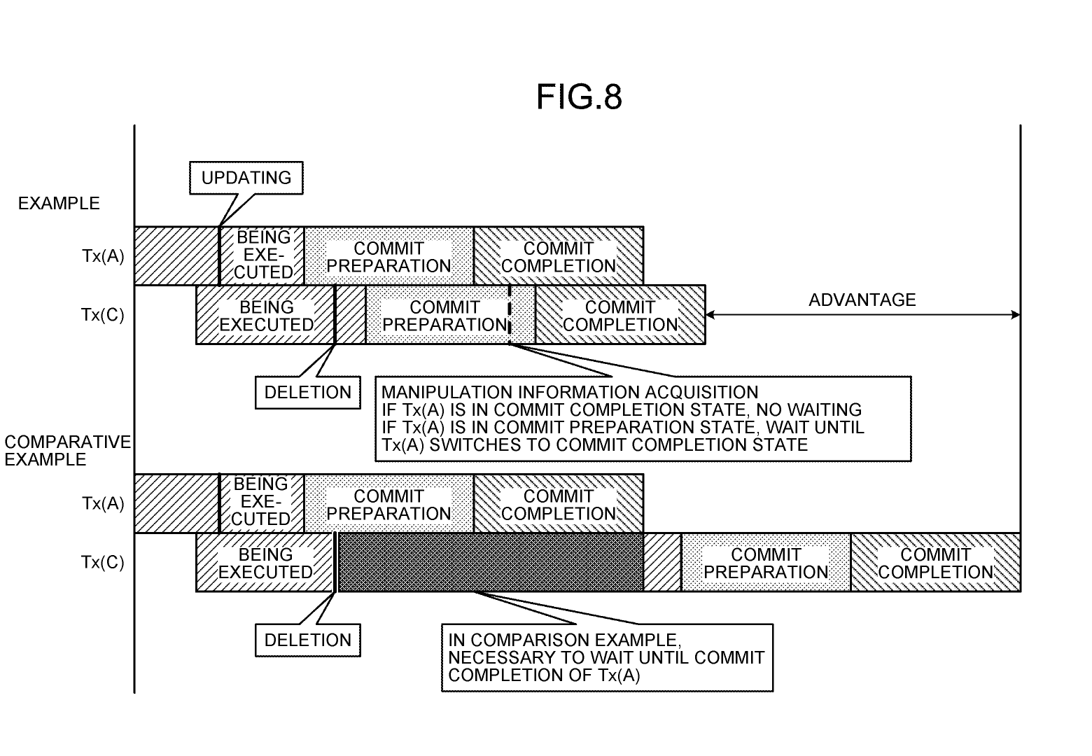

Herein, the attention is focused on the transactions Tx(A) and Tx(C). FIG. 8 is a diagram illustrating operations performed in the case (Example) in which the terminal device 1 according to the embodiment executes the transactions Tx(A) and Tx(C) illustrated in FIG. 7 and illustrating operations performed in Comparative example. When the transaction Tx(C) is executed after the transaction Tx(A), the following operations are performed.

In Example, in the case when the transaction Tx(C) deletes the data element 3 during the execution state of the transaction Tx(A), the transaction Tx(C) aborts. Moreover, in the case when the transaction Tx(C) deletes the data element 3 during the commit preparation state of the transaction Tx(A) and when the transaction Tx(C) does not perform speculative execution, the transaction Tx(C) aborts.

In contrast, in the case when the transaction Tx(C) deletes the data element 3 during the commit preparation state of the transaction Tx(A) and when the transaction Tx(C) performs speculative execution, the transaction Tx(C) carries on with deletion. Once the transaction Tx(C) switches to the commit preparation state, it waits for the transaction Tx(A) to switch to the commit completion state and then itself switches to the commit completion state. However, in case the transaction Tx(A) aborts, the Tx(C) also aborts in response.

In the case when the transaction Tx(C) deletes the data element 3 during the commit completion state of the transaction Tx(A), the transaction Tx(C) carries on with deletion.

Meanwhile, in the case when the transaction Tx(A) is executed after the transaction Tx(C), the operations described above are performed by interchanging (replacing) the transaction Tx(A) and the transaction Tx(C).

In this way, according to the embodiment, under the conditions that enable concurrent execution control of the data container 30, the transactions Tx(A) and Tx(B) do not interfere with each other. Besides, even in the case in which the upper level data elements to which the transactions Tx(A) and Tx(B) belong are changed, the consistency of operations is maintained.

In contrast, in Comparative example, in order for the transaction Tx(C) to perform deletion, it needs to wait for the commit completion of the transaction Tx(A). Thus, as compared to Comparative example, Example has the advantage that a plurality of transactions is switched to the commit completion state sooner.

### APPLICATION EXAMPLE

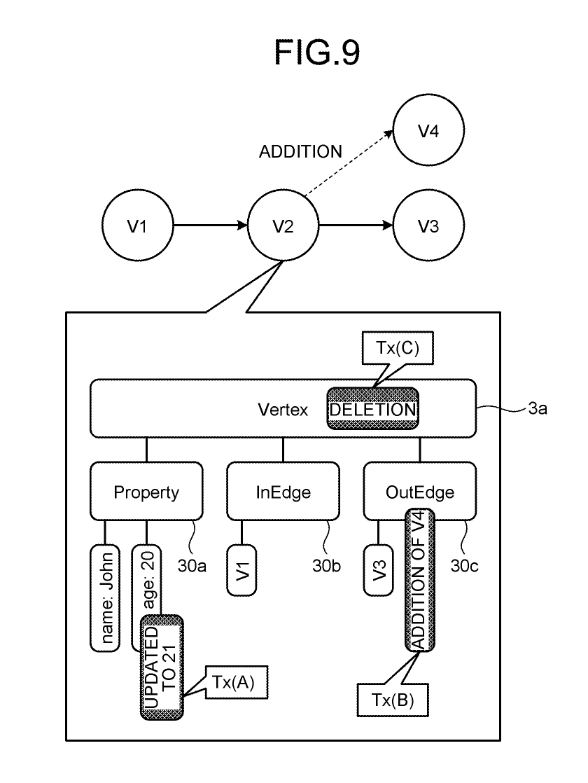

FIG. 9 is a diagram illustrating a configuration in the case in which the data elements and the data containers illustrated in FIG. 2 are applied to graph structure data. In FIG. 9, the data elements represent node elements (V1, V2, V3, and V4) and edge elements (including property containers (not illustrated)). For example, regarding the node V2 (Vertex 3a), the data container is configured with an property container 30a, an inward edge container 30b, and an outward edge container 30c. The property container 30a is a data container for storing property information containing an property name and a value. The inward edge container 30b is a data container for storing inward edges. The outward edge container 30c is a data container for storing outward edges.

In the graph structure data illustrated in FIG. 9, as a variation, it is also possible to think of an embodiment in which concurrent execution control can be performed not only at the container data granularity as described above in the embodiment but also at the granularity of the data containers (the property container 30a, the inward edge container 30b, and the outward edge container 30c). In this case, more particularly, when the manipulations with respect to the properties and the manipulations with respect to the edges are performed in different transactions, it becomes possible to perform concurrent execution without any mutual interference. That enables achieving enhancement in the execution concurrency.

In this way, in the terminal device 1, concurrent execution efficiency is enhanced by breaking the unit of concurrent execution control down to the granularity of individual manipulations with respect to the data in the data containers. Besides, at least one of the first detecting unit 14 and the second detecting unit 18 can detect competition with a manipulation for changing to the upper level data element. As a result, it becomes possible to secure the consistency in the manipulations.

Meanwhile, an information processing program executed in the terminal device 1 according to the embodiment is recorded in the form of an installable or executable file in a computer-readable recording medium such as a compact disk read only memory (CD-ROM), a flexible disk (FD), a compact disk readable (CD-R), or a digital versatile disk (DVD).

Alternatively, the information processing program executed in the terminal device 1 according to the embodiment can be saved as a downloadable file on a computer connected to the Internet or can be made available for distribution through a network such as the Internet.

While certain embodiments have been described, these embodiments have been presented by way of example only, and are not intended to limit the scope of the inventions. Indeed, the novel embodiment described herein may be embodied in a variety of other forms; furthermore, various omissions, substitutions and changes in the form of the embodiment described herein may be made without departing from the spirit of the inventions. The accompanying claims and their equivalents are intended to cover such forms or modifications as would fall within the scope and spirit of the inventions.

What is claimed is:

1. A terminal device comprising:
a memory unit configured to store therein a data element which holds a data container;
a managing unit configured to perform generation and deletion of a processing unit which executes a transaction for individually manipulating data with respect to the data element and the data container stored in the memory unit;
a manipulation recording unit configured to, while a transaction is being executed by the processing unit, record manipulation information containing manipulation details with respect to target data for manipulation and identification information which enables transaction identification; and
at least one of a first detecting unit and a second detecting unit configured to detect presence or absence of competition which may cause a loss in the consistency of data, the first detecting unit detecting competition between manipulation with respect to a data element and manipulation with respect to a data container during an execution state of a transaction as set by the processing unit, and the second detecting unit detecting competition between manipulation with respect to a data element and manipulation with respect to a data container based on the manipulation information during a commit preparation state of a transaction as set by the processing unit, wherein
when at least either one of the first detecting unit and the second detecting unit detects competition, the processing unit aborts the transaction.

2. The device according to claim 1, wherein
a data element stored in the storing unit is a graph element expressed either as a node element representing a node or as an edge element representing an edge, and
the node element has a data container that stores therein at least information of an edge connected to a node.

3. The device according to claim 2, wherein the node element has at least one of a data container storing therein an outward edge and a data container storing therein an inward edge.

4. The device according to claim 2, wherein
the node element as well as the edge element has a data container which stores therein property information, and
the property information is configured with property name and a value.

5. An information processing method for storing data in a terminal device that includes a memory device to store therein a data element which holds a data container, the method comprising:
performing generation and deletion of a processing unit which executes a transaction for individually manipulating data with respect to the data element and the data container stored in the memory unit to mange active transactions;
recording, while a transaction is being executed by the processing unit, manipulation information containing manipulation details with respect to target data for manipulation and identification information which enables transaction identification;
performing at least one of first-detecting and second-detecting for detecting presence or absence of competition which may cause a loss in the consistency of data, the first-detecting including detecting competition between manipulation with respect to a data element and manipulation with respect to a data container during an execution state of a transaction as set by the processing unit, and the second-detecting including detecting competition between manipulation with respect to a data element and manipulation with respect to a data container based on the manipulation information during a commit preparation state of a transaction as set by the processing unit; and
aborting the transaction when competition is detected in at least one of the first-detecting and the second-detecting.

6. The method according to claim 5, wherein
a data element stored in the storing unit is a graph element expressed either as a node element representing a node or as an edge element representing an edge, and
the node element has a data container that stores therein at least information of an edge connected to a node.

7. The method according to claim 6, wherein the node element has at least one of a data container storing therein an outward edge and a data container storing therein an inward edge.

8. The method according to claim 6, wherein
the node element as well as the edge element has a data container which stores therein property information, and
the property information is configured with property name and a value.

9. A computer program product comprising a computer-readable medium containing an image processing program for storing data in a terminal device that includes a memory device to store therein a data element which holds a data container, wherein the program, when executed by a computer, causes the computer to perform:
performing generation and deletion of a processing unit which executes a transaction for individually manipulating data with respect to the data element and the data container stored in the memory unit to mange active transactions;
recording, while a transaction is being executed by the processing unit, manipulation information containing manipulation details with respect to target data for manipulation and identification information which enables transaction identification;
performing at least one of first-detecting and second-detecting for detecting presence or absence of competition which may cause a loss in the consistency of data, the first-detecting including detecting competition between manipulation with respect to a data element and manipulation with respect to a data container during an execution state of a transaction as set by the processing unit, and the second-detecting including detecting competition between manipulation with respect to a data element and manipulation with respect to a data container based on the manipulation information during a commit preparation state of a transaction as set by the processing unit; and
aborting the transaction when competition is detected in at least one of the first-detecting and the second-detecting.

10. The product according to claim 9, wherein
a data element stored in the storing unit is a graph element expressed either as a node element representing a node or as an edge element representing an edge, and
the node element has a data container that stores therein at least information of an edge connected to a node.

11. The product according to claim 10, wherein the node element has at least one of a data container storing therein an outward edge and a data container storing therein an inward edge.

12. The method according to claim 10, wherein
the node element as well as the edge element has a data container which stores therein property information, and
the property information is configured with property name and a value.
